(19) United States
(12) Patent Application Publication
(10) Pub. No.: US 2016/0317258 A1
(43) Pub. Date: Nov. 3, 2016

(54) BLANK FOR THE PRODUCTION OF A DENTAL ELEMENT

(71) Applicant: Heinrich STEGER, Bruneck (IT)

(72) Inventor: Heinrich STEGER, Bruneck (IT)

(21) Appl. No.: 15/139,498

(22) Filed: Apr. 27, 2016

(30) Foreign Application Priority Data
Apr. 30, 2015 (AT) A 50352/2015

(51) Int. Cl. A61C 13/00

(52) U.S. Cl. CPC A61C 13/0022

(57) ABSTRACT

A blank for the production of a dental element includes a first side, a second side and at least one main holding surface for holding the blank at a holding device. The holding surface is spaced from the second side, and the blank has a standard holding thickness between the main holding surface and the second side. The blank includes at least one auxiliary holding surface for holding the blank at a holding device, and the auxiliary holding surface is spaced from the second side. The blank has a non-standard holding thickness between the at least one auxiliary holding surface and the second side, and the standard holding thickness is larger than the non-standard holding thickness.

The present invention concerns a blank for the production of a dental element (e.g. a dental model or a dental replacement part), including a first side, a second side and at least one main holding surface for holding the blank at a holding device, wherein the holding surface is spaced from the second side and wherein the blank has a standard holding thickness between the main holding surface and the second side.

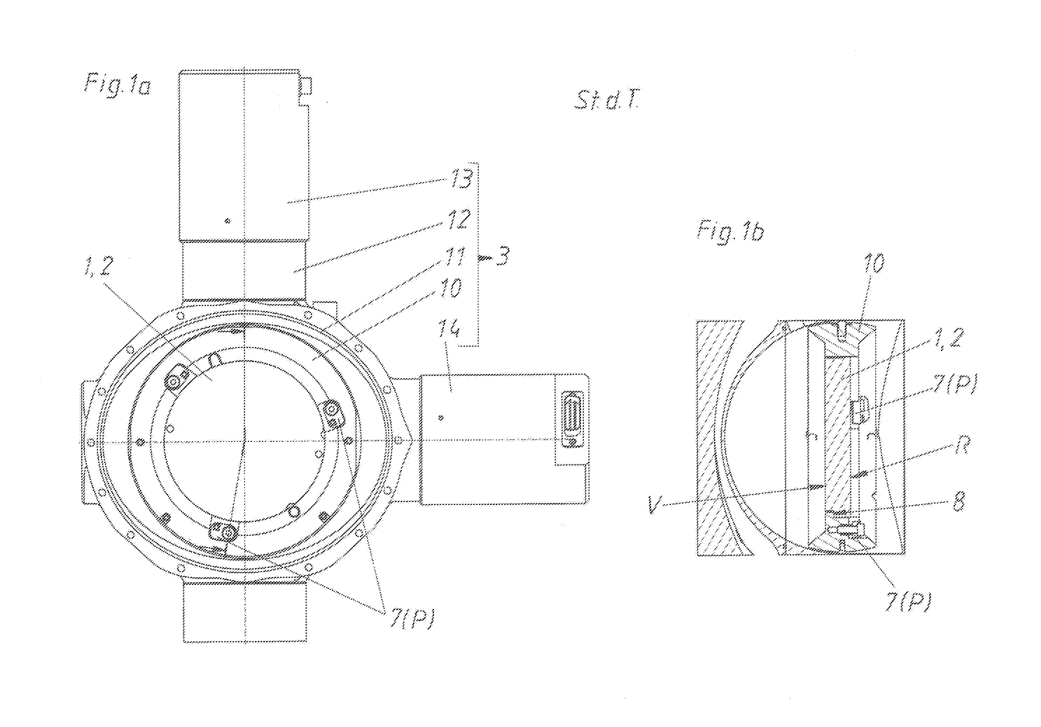

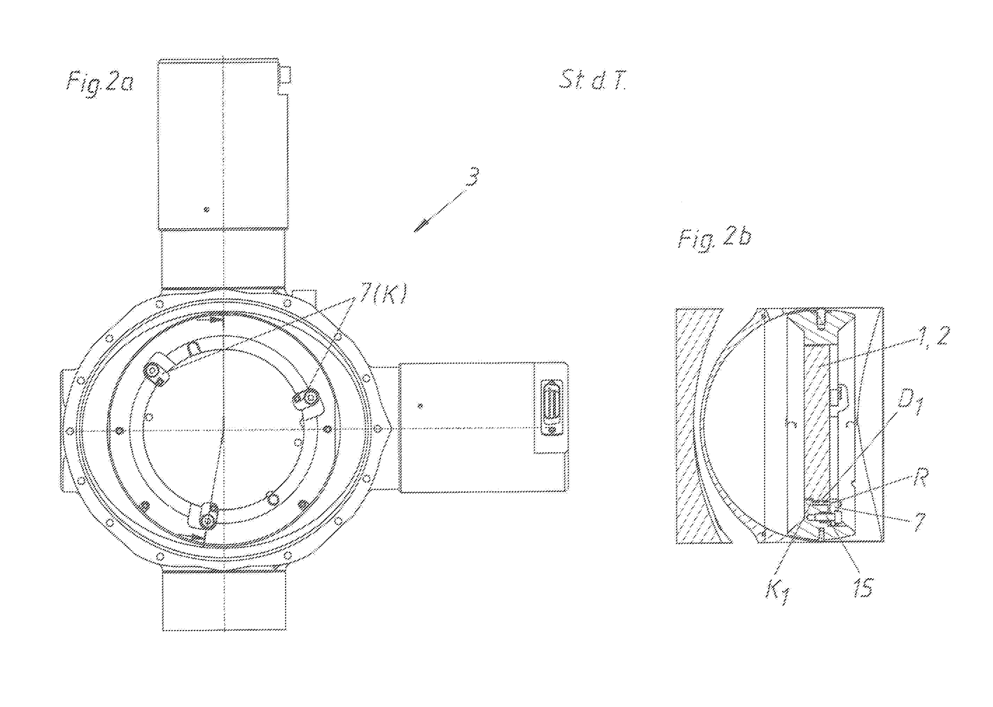

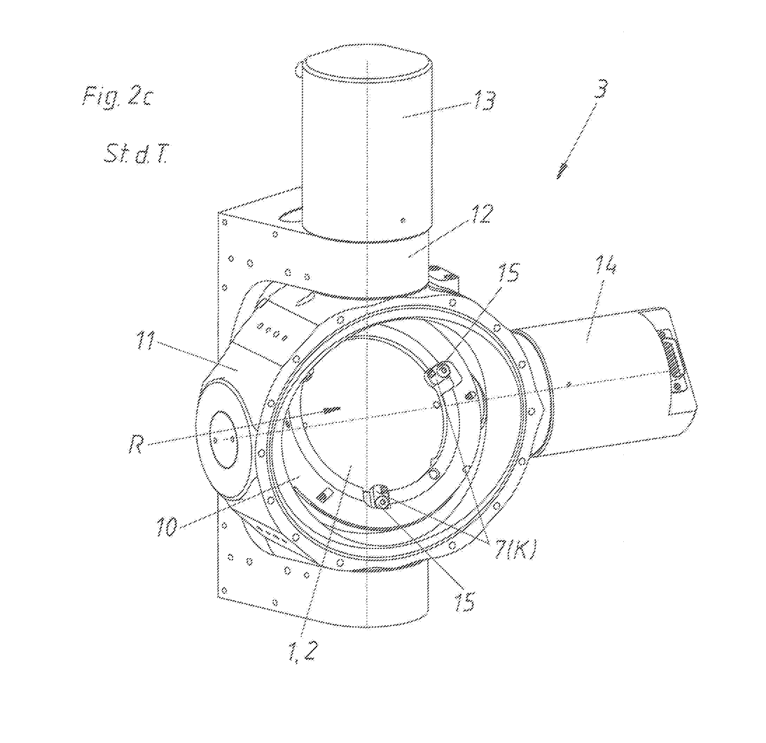

Such a blank according to the prior art is disclosed in FIG. 1a to 2c which are described in the following.

FIG. 1a shows a holding device 3 for a blank 1, 2. Such a holding device is produced, offered and sold by the applicant for some time past. The holding device comprises a substantially C-shaped carrier 12 on which the drive motors 13 and 14 are arranged. The outer holding ring 11 is rotationally mounted to the carrier 12. The inner holding ring 10 is rotationally mounted to the outer holding ring 11. In the inner holding ring 10 the blank 1, 2 can be chucked via the tensioning device 6 and its tensioning parts 7, wherein the tensioning parts 7 are in a passive state P in FIG. 1a. The arrows indicated in FIG. 1a refer to a section axis, wherein the corresponding sectional view is shown in FIG. 1b. It can be recognized that the blank 1, 2 is inserted in the inner holding ring 10 and abuts a tensioning surface 8. The blank 1, 2 has a first side (corresponds to the front side V) and a second side (corresponds to the back side R).

In order to chuck the blank 1, 2 at the holding device 3, according to FIGS. 2a and 2b the tensioning parts 7 are rotated about the tensioning pins 15 of the tensioning device 6, whereby the tensioning parts 7 are reaching a tensioning state K. In this tensioning state K the blank 1, 2 is clamped between the tensioning surfaces 8 and the tensioning parts 7 of the tensioning device 6 via the main holding surfaces K₁ arranged at the blank 1, 2 and the back side R. The blank 1, 2 has a standard holding thickness D₁ between its back side R and each main holding surface K₁. In a preferred embodiment this standard holding thickness D₁ is 10 mm. FIG. 2c shows a perspective view of the holding device 3 with a chucked blank 1, 2. Also the rotational axes of both holding rings 10 and 11 can be recognized.

Such blanks known in the prior art can be machined in a proven manner chronological after each other in a holding device whereby dental replacement parts are produced.

The object of the present invention is to provide a modified or improved blank compared with the prior art. Particularly, the blank should be versatile. Moreover, working should be simplified for a user. Further, working effort should be reduced. Especially, it should be possible to produce several dental elements with working steps as few as possible.

This is attained by a blank with the features according to claim 1. Thus, the blank according to the invention includes at least one auxiliary holding surface for holding the blank at a holding device, wherein the auxiliary holding surface is spaced from the second side, wherein the blank has a non-standard holding thickness between the at least one auxiliary holding surface and the second side, wherein the standard holding thickness is larger than the non-standard holding thickness. Thereby it is possible to chuck—in one and the same holding device—a single blank via the at least one main holding surface or to chuck two blanks at the same time via the respective narrower auxiliary holding surfaces. In this way it is possible to machine dental elements out of two different blanks after one single fastening motion without a new fastening motion or re-chucking therebetween. Generally, the at least one narrower non-standard holding thickness facilitates chucking of two such blanks in one and the same holding device.

Protection is also sought for a set according to claim 12. Thus, the addition of the non-standard holding thickness of the first blank and the non-standard holding thickness of the second blank results in the standard holding thickness. Thereby it is possible to provide two different blanks for a holding device, which still suit in an unmodified holding device. For example, the non-standard holding thickness of a blank can be approx. 7 mm, whereas the non-standard holding thickness of the other blank is approx. 3 mm, so that it results in the standard holding thickness when two blanks are chucked adjacent to each other.

However, for an easy mass production it is preferably provided that the standard holding thickness is twice as big as the non-standard holding thickness. In a specific embodiment this means for example that the non-standard holding thickness is always 5 mm. Of course, also larger or smaller dimensions are possible as long as sufficient support is guaranteed and the blanks can be chucked in the holding device.

For an easy mounting of the blanks at the holding device it is preferably provided that several, preferably three, main holding surfaces are arranged on the blank regularly spaced from each other, preferably spaced by 120° each. Further, it is an advantage when several, preferably three, auxiliary holding surfaces are arranged on the blank regularly spaced from each other, preferably spaced by 120° each. In order to guarantee sufficient space at the blank for chucking, it is preferably provided that the main holding surface and the auxiliary holding surface are arranged at the blank spaced from each other. There it can be provided that the several main holding surfaces and the several auxiliary holding surfaces are arranged on the blank regularly spaced from each other, preferably spaced by 60° each.

In principle, the form of the blank is arbitrary. For example, the blank can be formed as a cuboid, as a jaw arch, as a cube or similar. Particularly preferred it is provided that the blank is disk-shaped and the first side and the second side are formed substantially flat and parallel to each other and the circumferential surface is aligned substantially rectangular to the first side and to the second side.

Basically, the main holding surface and the auxiliary holding surface can be aligned arbitrary at the blank as long as the surfaces match in accordance with the counter surfaces of the tensioning device. When having a disk-shaped blank it is preferably provided that the at least one main holding surface and the at least one auxiliary holding surface are aligned parallel to the first side and to the second side. Preferably, the standard holding thickness and the non-standard holding thickness are each measured parallel to the circumferential surface.

If the blank is disk-shaped it is particularly preferred that the circumferential surface is substantially in a shape of a circular cylinder jacket. Of course, sub-sections can have deviations from the shape of a circular cylinder jacket. Particularly it can be provided that the at least one main holding surface and the at least one auxiliary holding surface in the form of recesses are formed in the first side and in the circumferential surface. Preferably, the circumferential surface of the blank is fully in the shape of a circular cylinder jacket outside the area of the recesses.

The invention not only concerns a specific blank, but also an arrangement including two blanks and a holding device for holding both blanks, wherein both blanks each have a first side formed as a front side and a second side formed as a back side.

Such a holding or chucking of two blanks in a work table application (holding device) is disclosed in the DE 10 2010 061 116 A1, especially in its illustration 9.1d. Both chucked blanks are abutting each other via a contact surface. It is adverse that the blanks are chucked in the work table application via a large part of the front sides and back sides respecively. Thus, only a small protruding area can be machined anyway.

Therefore, a further object of the invention is to provide an arrangement which allows an easy and effective machining of two chucked blanks.

This is attained by the features of claim 15. Thus, it is provided that in a chucked state both blanks are facing to each other with their back sides and substantially the complete front sides of the blanks are accessible. Thereby, in order to machine the desired dental elements out of the whole blank, it is not anymore necessary that the blanks are re-chucked or inserted differently. “Substantially the complete front sides” means that (in a top view) at least 80%, preferably at least 90%, particularly preferred at least 95%, of the front sides are accessible for a processing device in a chucked state.

In such an arrangement the chucking of both blanks can be effected arbitrary as long as both front sides are accessible completely. However, preferably it is provided that both blanks include at least one auxiliary holding surface for holding the blank at a holding device, wherein the auxiliary holding surface is spaced from the second side, wherein the blank has a non-standard holding thickness between the at least one auxiliary holding surface and the second side, wherein the standard holding thickness is twice as large as the non-standard holding thickness.

For an easy chucking of both blanks it is preferably provided that the holding device has at least one, preferably three, tensioning device, wherein by the tensioning device the blanks can be tensioned via their auxiliary holding surfaces to the holding device. In a specific embodiment it is further provided that—when there are several tensioning devices—each tensioning device has a movable tensioning part and a tensioning surface, wherein in a chucked state an auxiliary holding surface of one of the blanks abuts the tensioning surface and an auxiliary holding surface of the other blank abuts the tensioning part. Of course, it is possible that also a single blank is chucked via the main holding surface and the back side in the same tensioning device.

In principle, it is possible that the tensioning device is applicable for chucking differently thick blanks. So it is possible that the tensioning device has tensioning parts and tensioning surfaces which are variably adjustable to each other. However, for a simple construction it is provided that the movable tensioning part and the tensioning surface of the tensioning device have a substantially unalterable distance to each other, preferably corresponding to the standard holding thickness. In this way it is possible to chuck one blank as well as two blanks in one and the same, simply constructed tensioning device.

For an easy production, storing and use it is preferably provided that both blanks are formed identical.

In principle, it is not necessary that the blanks touch each other via their back sides in the chucked state. However, for an easy chucking without any intermediate piece it is preferably provided that in the chucked state the blanks are abutting each other partly or fully via their back sides which are facing each other.

According to a further preferred embodiment such an arrangement comprises a processing device for machining both blanks chucked in the holding device, wherein both blanks can be machined via their substantially completely accessible front sides by the processing device. Therefore, the processing device and the holding device are movable relative to each other in such a way that both front sides can be machined.

Protection is also sought for a method for chucking two blanks according to the invention at a holding device. This method comprises the steps inserting the first blank in the holding device, wherein the first blank abuts a tensioning surface of a tensioning device of the holding device via the at least one auxiliary holding surface, inserting the second blank in the holding device, wherein the blanks are facing with their back sides towards each other and the at least one auxiliary holding surface of the second blank is aligned corresponding to the at least one auxiliary holding surface of the first blank, and moving the tensioning part of the tensioning device of the holding device from a passive state into a tensioning state, so that in the tensioning state the tensioning part abuts the at least one auxiliary holding surface of the second blank and both blanks are commonly chucked via their auxiliary holding surfaces between the tensioning part and the tensioning surface of the tensioning device of the holding device.

Further details and advantages of the present invention are described more fully hereinafter by means of the specific description with reference to the embodiments by way of example illustrated in the drawings, in which:

FIGS. 1a and 1b show a holding device with a blank according to the prior art with a tensioning device in a passive state,

FIG. 2a to 2c show a holding device with a blank according to the prior art with a tensioning device in a tensioning state,

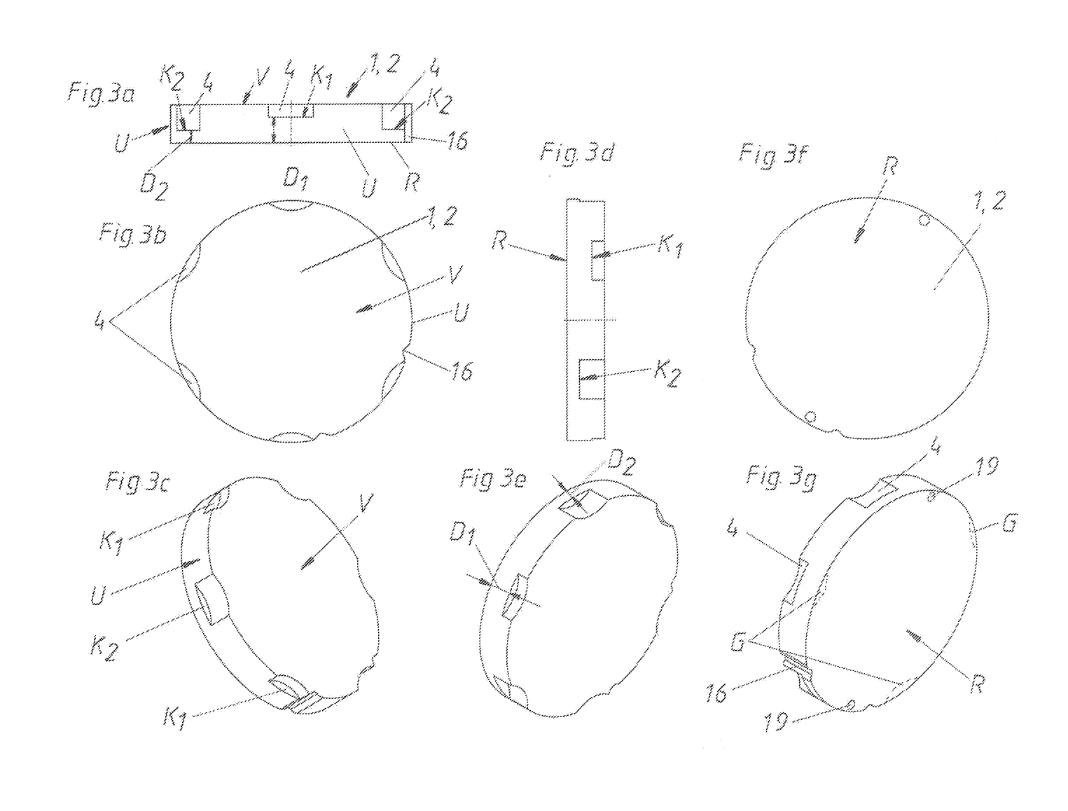

FIG. 3a to 3g show different views of a blank according to the invention,

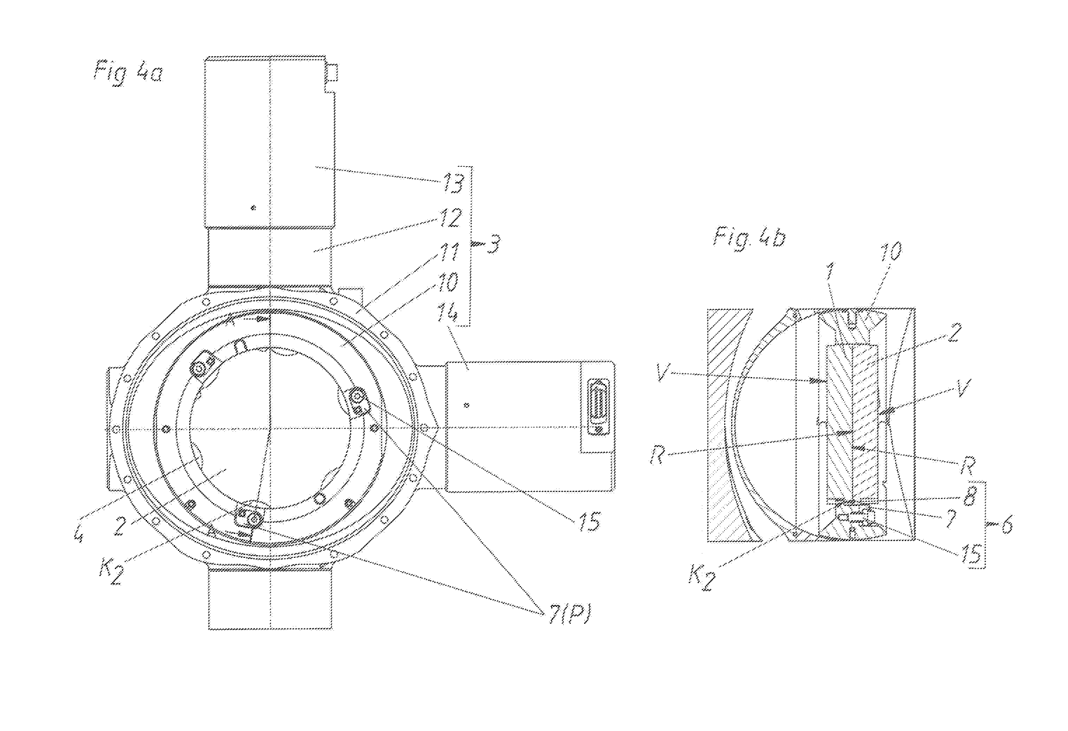

FIGS. 4a and 4b show two blanks inserted in a holding device,

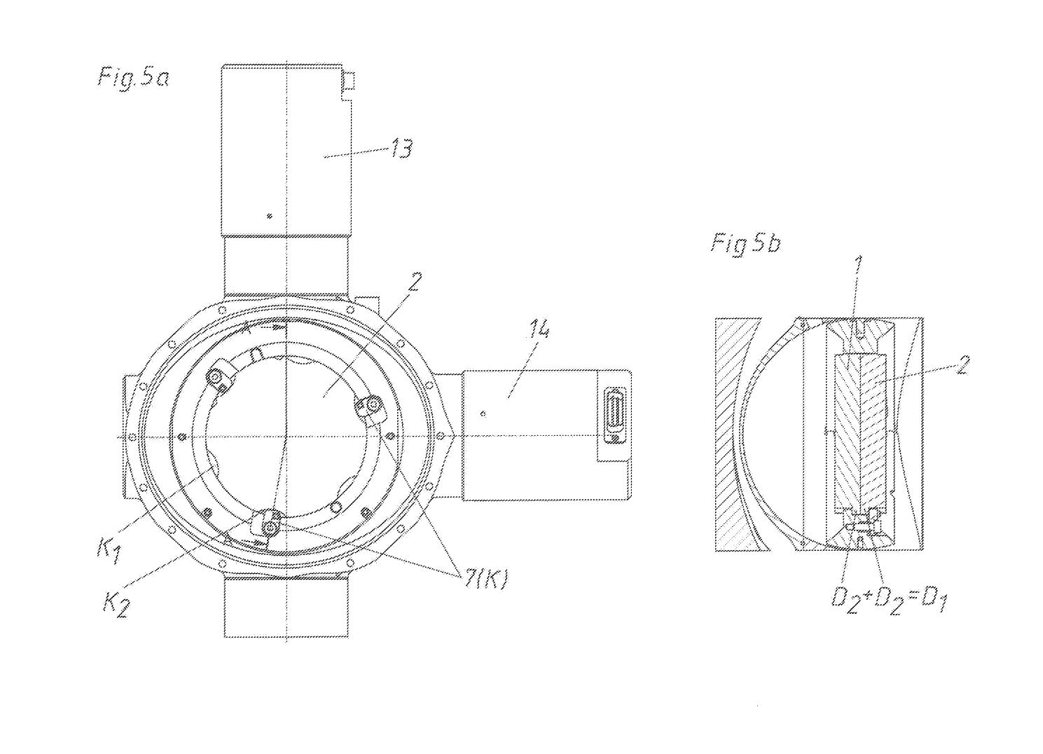

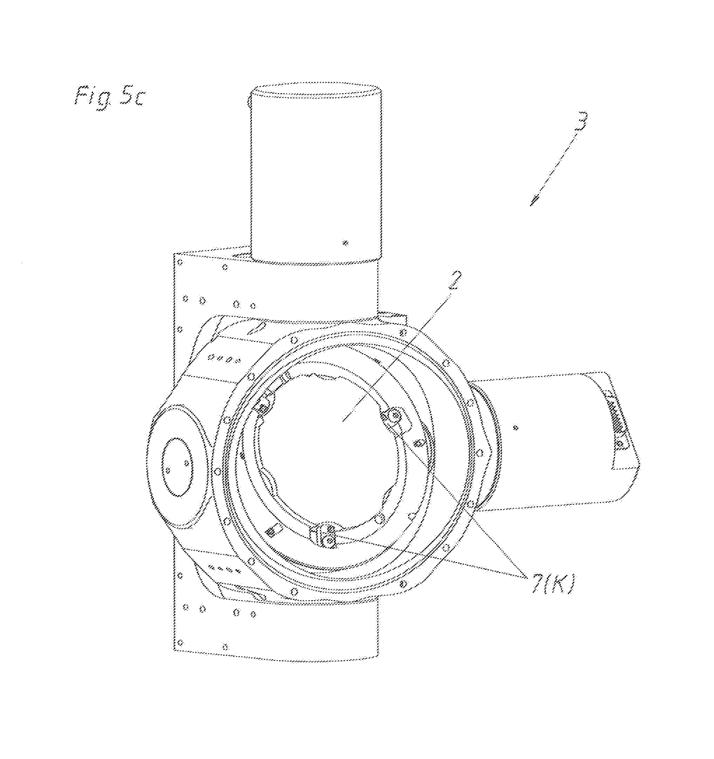

FIG. 5a to 5c show both inserted blanks in a tensioning state of the tensioning device,

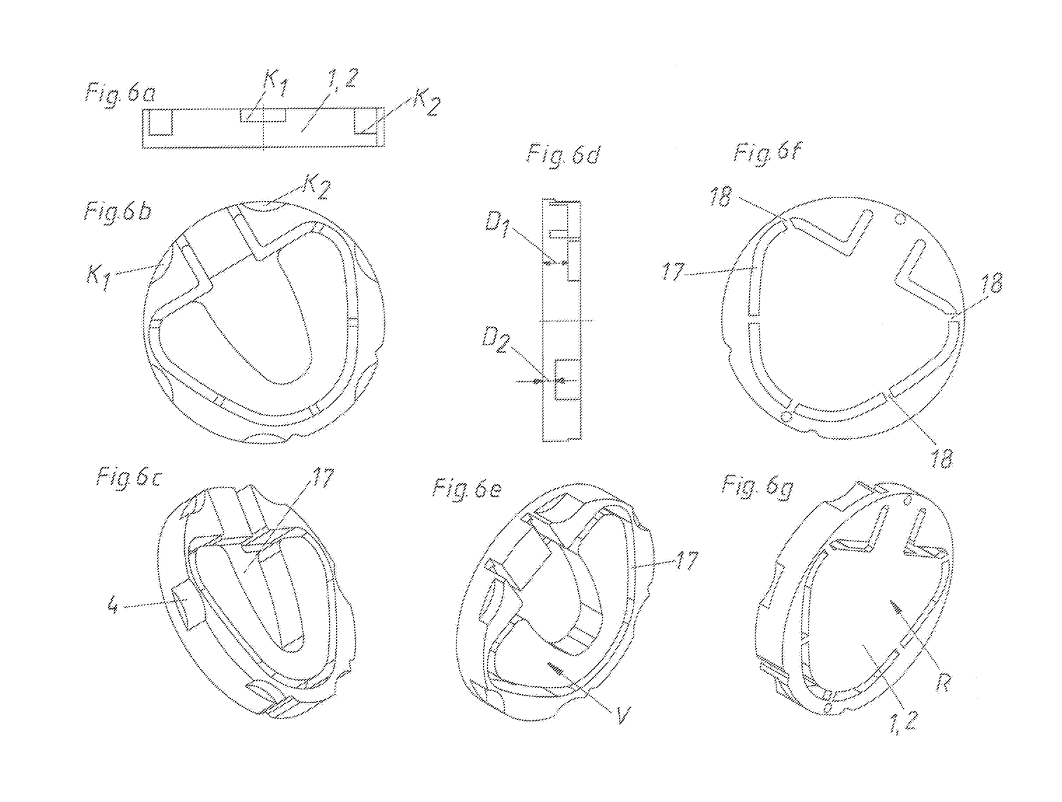

FIG. 6a to 6g show different views of a pre-milled blank,

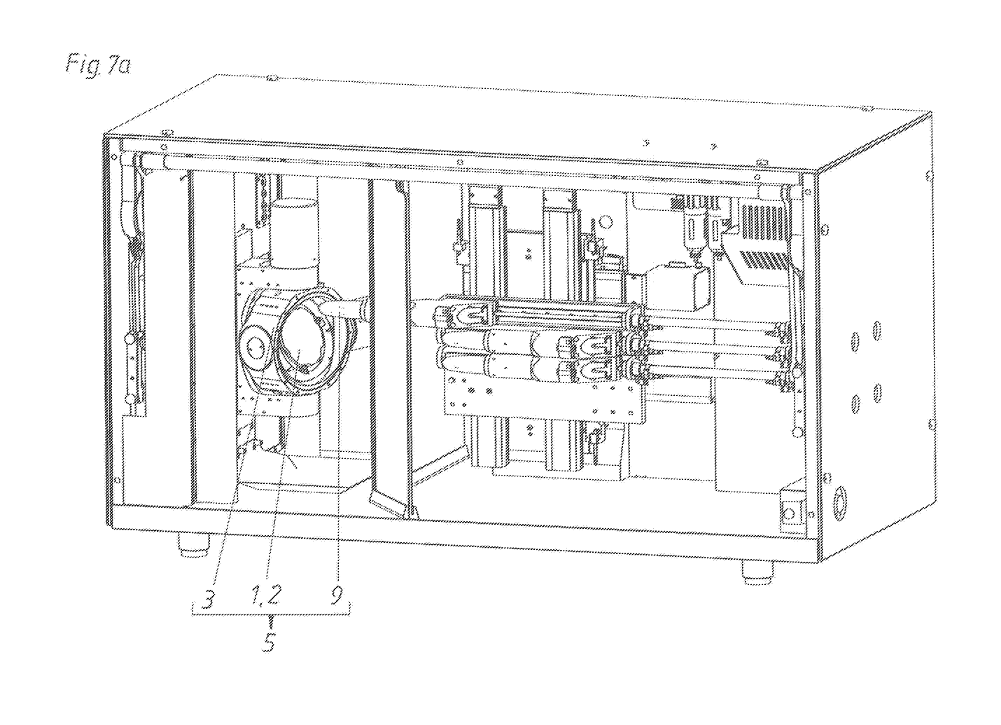

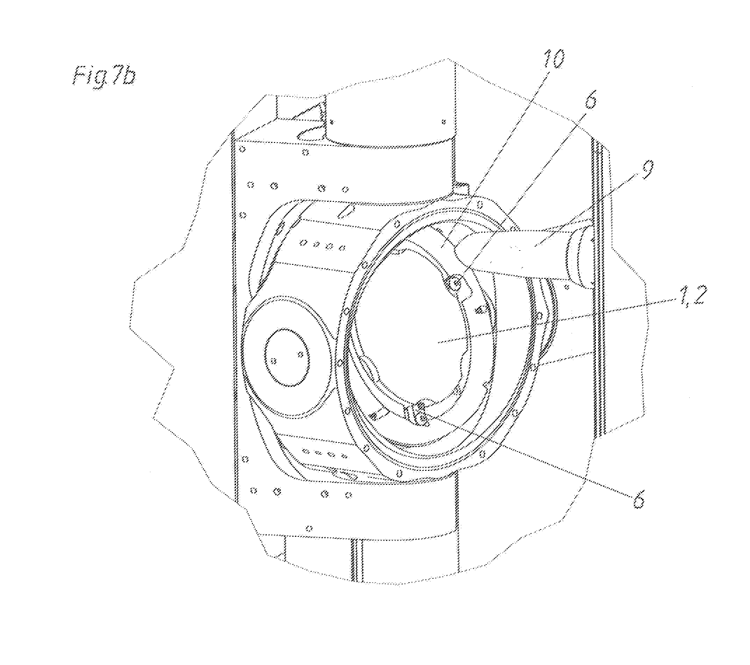

FIGS. 7a and 7b show different views of an arrangement along with a holding device and a processing device,

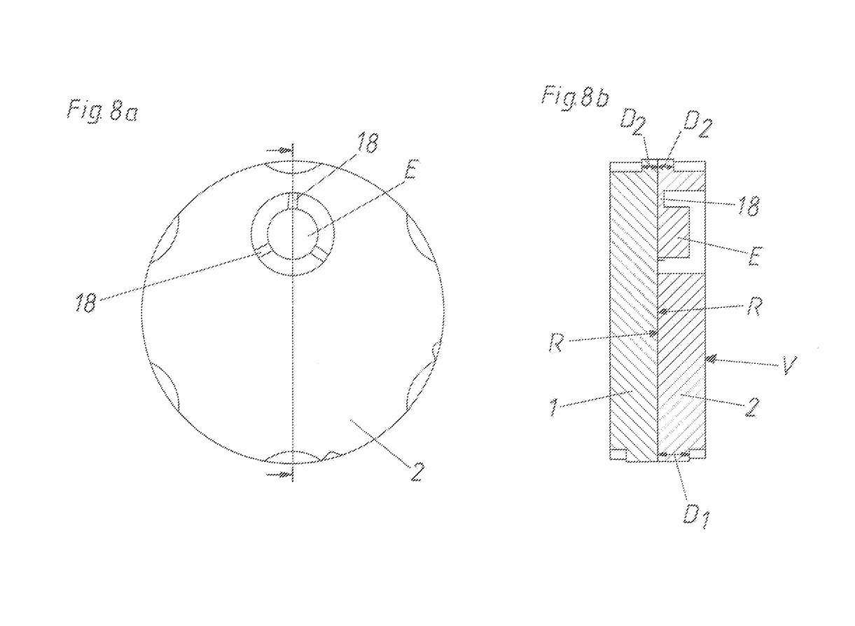

FIGS. 8a and 8b show blanks in different views, wherein a dental replacement part is already machined out of the blank,

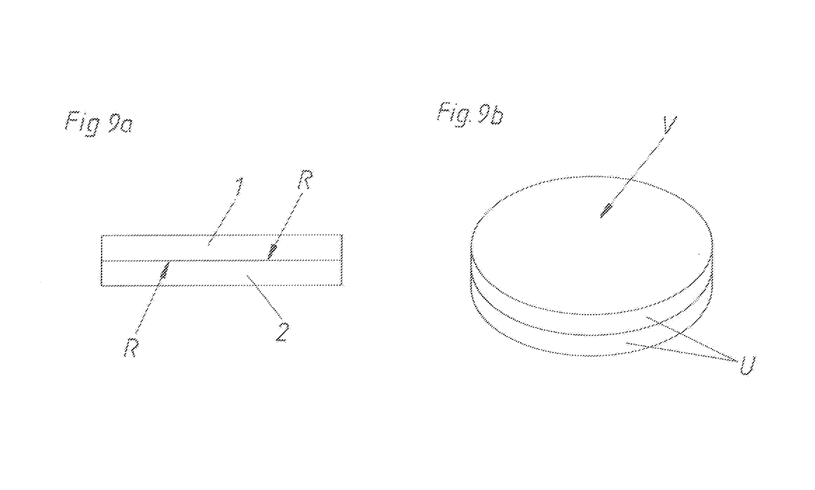

FIG. 9a to 12b show alternative embodiments of two blanks partly abutting each other and

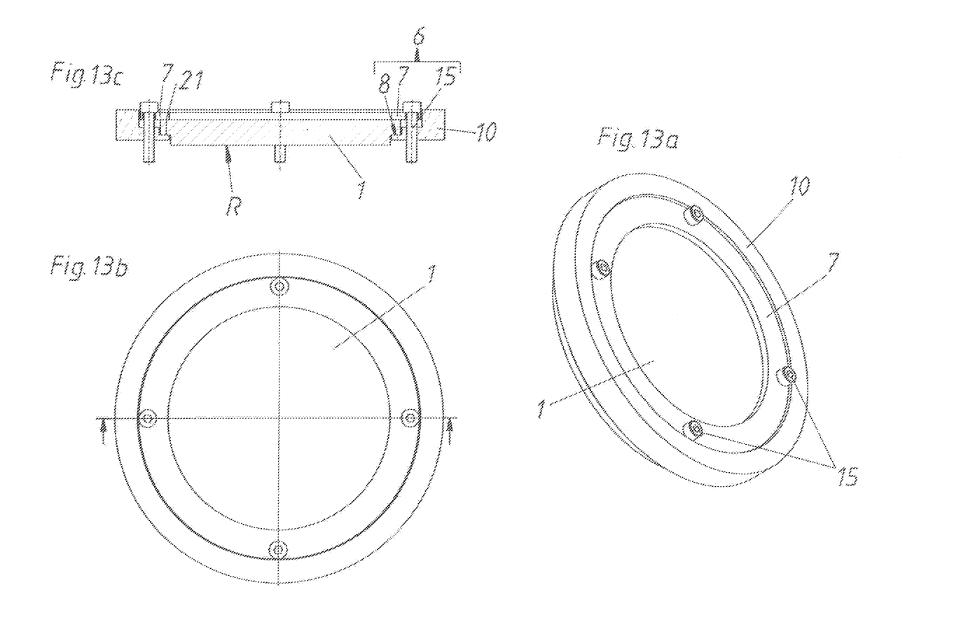

FIG. 13a to 16c show an alternative embodiment of a holding device with one and with two chucked blanks respectively.

FIG. 1a to 2c—which show the prior art—were already discussed in the introduction of the description.

FIG. 3a shows in a side view the circumferential surface U of a blank 1, 2 which is substantially formed as a circular cylinder jacket. Several recesses 4 are present in this circular cylinder jacket-shaped circumferential surface U. On the blank 1, 2 these recesses 4 form main holding surfaces K₁ and auxiliary holding surfaces K₂ which are parallel to the front side V and the back side R. Further, also a part of the second side (corresponds to the back side R) simultaneously forms a counter holding surface G (see FIG. 3g). The main holding surfaces K₁ in the area of the recesses 4 and the back sides R are each spaced from each other by the standard holding thickness D₁. In the area of the auxiliary holding surfaces K₂ the blank 1, 2 has a non-standard holding thickness D₂ as distance to the back side R. The non-standard holding thickness D₂ is smaller than the standard holding thickness D₁, preferably half as small. Also from FIG. 3b to 3g the same components and surfaces respectively are recognizable. FIG. 3a to 3g also show the at least one positioning groove 16 via which the blanks 1, 2 are chucked at a suitable position in the holding device 3. Thereby, it is also guaranteed that—when chucking two blanks 1, 2—the auxiliary holding surfaces K₂ of both blanks 1, 2 are positioned correctly to each other, i. e. axially opposing to each other. Alternatively, it is possible to realize a positioning via the positioning bores 19 formed in the back side R.

FIG. 4a shows a holding device 3 which has an inner holding ring 10, an outer holding ring 11, a preferably C-shaped carrier 12 and two drive motors 13 and 14 for both holding rings 10 and 11. As can be seen in FIG. 4b, both blanks 1 and 2 are introduced in the inner holding ring 10. The first blank 1 abuts the tensioning surfaces 8 of the tensioning device 6 via its auxiliary holding surfaces K₂. The tensioning device 6 comprises the tensioning surfaces 8, the tensioning parts 7 and the tensioning pins 15. In FIGS. 4a and 4b the tensioning parts 7 are still in the passive state P.

In contrast, according to FIG. 5a to 5c the tensioning parts 7 are pivoted about the tensioning pins 15 to reach the tensioning state K. Thereby, the tensioning parts 7 abut the auxiliary holdings surfaces K₂ of the second blank 2. As the first blank 1 according to FIGS. 4b and 5b already abuts the tensioning surface 8 of the inner holding ring 10, by the tensioning device 6 both blanks 1 and 2 are simultaneously chucked at the holding device 3. As the addition of the non-standard holding thicknesses D₂ of both blanks 1 and 2 results in the standard holding thickness D₁, it is possible to chuck both blanks 1 and 2 via the respective auxiliary holdings surfaces K₂ in the same manner as one single blank 1, 2 is chucked via the main holding surface K₁ and the back side R. Thus, by chucking two blanks 1 and 2 simultaneously, an efficient use is possible without performing a modification of the holding device 3. No re-chucking is necessary between the machining of both blanks 1 and 2.

In order to simplify the machining of the blanks 1 and 2 for a dental technician, the blanks 1, 2 can be pre-machined or pre-milled according to FIG. 6a to 6g. Especially, the blanks 1, 2 (blocks) can be thus formed in such a way that the remaining geometry is adapted to a dentition. This leads to the advantage that not the whole block has to be machined anymore. Therefore, the milling grooves 17 do not have to be made with a tool by the dental technician but are already delivered with milling grooves 17. The dentition-shaped inner area of the blank 1, 2 is connected to the outer area via connections bars 18.

FIG. 7a shows an arrangement 5, comprising a holding device 3, two blanks 1 and 2 chucked at the holding device 3 and a processing device 9. This processing device 9 can comprise a spindle as shown in FIG. 7b. A milling tool or a similar tool can be arranged at the front side of the spindle in order to machine the blanks 1 and 2 successively at the front side V. For this, the inner holding ring 10 is rotatable about an axis by at least 180°, preferably by complete 360°. In FIG. 7b it is recognizable that in a chucked state the complete front sides V of the blanks 1 and 2 are substantially fully accessible. Thereby, unnecessary re-chucking is prevented and a complete machining of dental elements E out of two blanks 1 and 2 is possible without an intermediate work of a dental technician.

FIGS. 8a and 8b show two blanks 1 and 2, wherein a only schematically indicated dental element E is already machined from the second blank 2. This dental element E is connected to the remaining areas of the blank 2 via the bars 18. Later, this dental element E is separated from the second blank 2 by the dental technician or by a particular tool. For example, dental elements E can be caps, bridges or the like. Dental models are preferably produced from these blanks in order to successively make simulations of dentition or jaw motions. Also carrier models for dentures can be produced. For example, the blanks 1 and 2 can be made of zirconium, metal, cast or plastic. FIG. 8b shows that the non-standard holding thicknesses D₂ in the area of the auxiliary holding surfaces K₂ is added to the standard holding thickness D₁.

All yet shown and described embodiments are suitable for being applied in a concrete variant of the holding device of the applicant. However, it is also possible that the present invention is being applied analogously in every holding device. This is described by the embodiments more fully hereinafter.

FIGS. 9a and 9b show two blanks 1 and 2 which are abutting each other via their back sides R. Such simple cylindrical blanks 1 and 2 can be chucked in an arrangement according to the invention and can be machined from both substantially fully accessible front sides V.

The same applies to the blanks 1 and 2 according to FIGS. 10a and 10b, wherein these blanks 1 and 2 each have a chamfered surface 20.

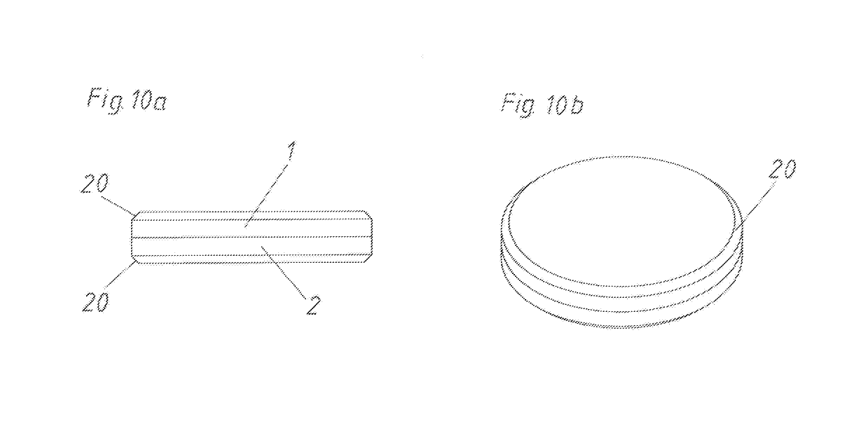

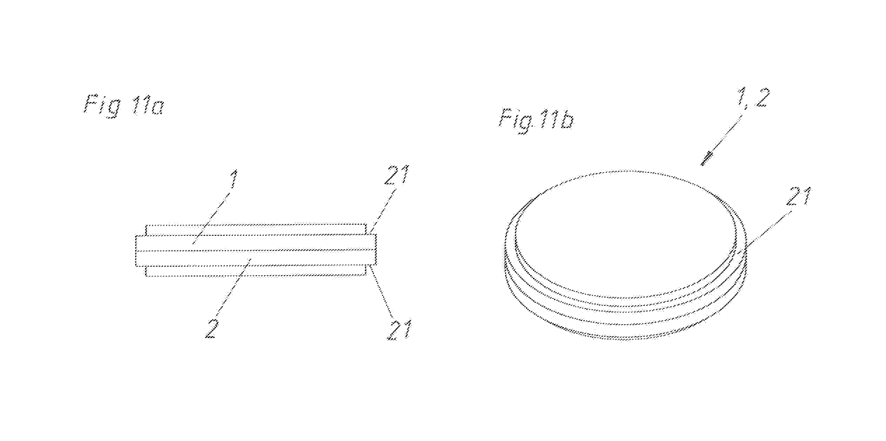

FIGS. 11a and 11b show blanks 1 and 2 with a continuous peripheral step 21.

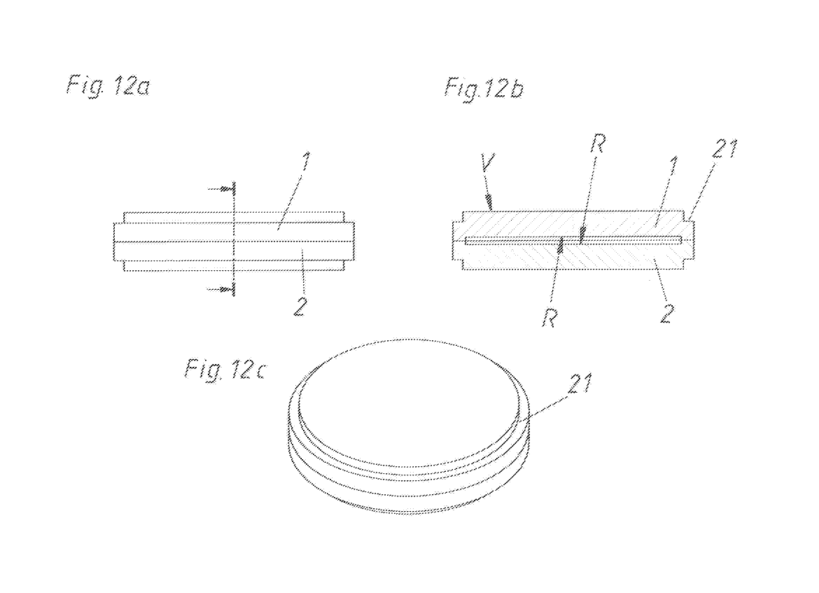

Such a step 21 also exists on the blanks 1 and 2 according to FIG. 12a to 12c. A difference is that the blanks 1 and 2 are not fully abutting each other over their back sides R but only contact each other in a peripheral area (edge region).

An alternative embodiment of a tensioning device 6 is shown in FIG. 13a to 16c. These embodiments have in common that the tensioning device 6 comprises a ring-shaped, one-pieced tensioning part 7, several tensioning pins 15 in the form of screws and the tensioning surfaces 8 as part of the (inner) holding ring 10.

In order to chuck one single blank 1, according to FIG. 13c the blank 1 is initially placed on the tensioning surface 8 via the step 21. Afterwards, the ring-shaped tensioning part 7 is placed on the opposite side of the blank 1. Then, the tensioning pins 15 are introduced in the corresponding recesses of the tensioning part 7. An external thread is formed on each tensioning pin 15, wherein the external thread corresponds with an internal thread formed in the holding ring 10. By rotating these tensioning pins 15 the tensioning part 7 presses onto the blank 1, whereby the blank 1 is clamped—and therefore chucked—between the tensioning part 7 and the tensioning surface 8.

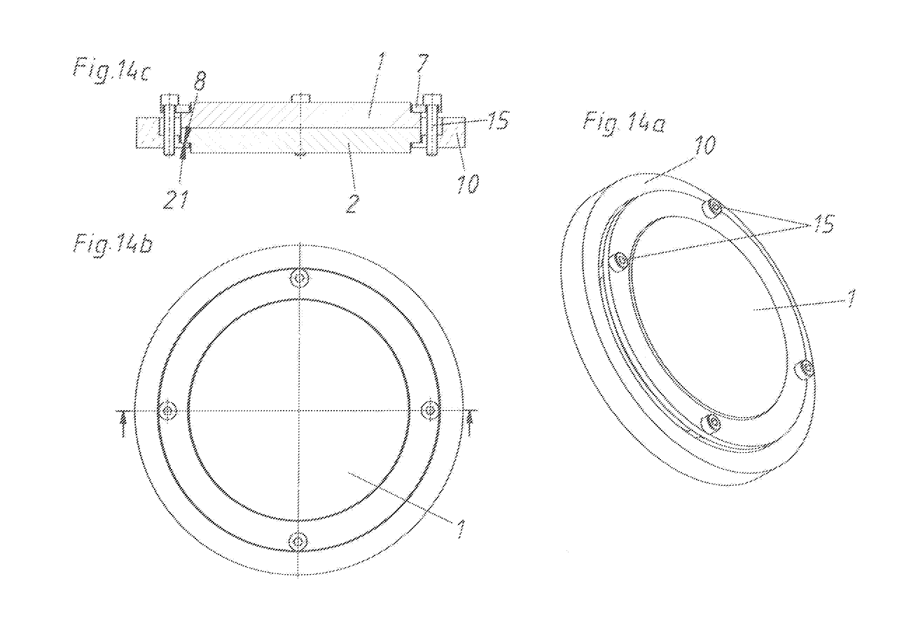

In an analogous manner the two blanks 1 and 2 according to FIG. 14a to 14c are chucked at a holding device 3. As the distance between the tensioning part 7 and the tensioning surface 8 is variable in the tensioning state K—contrary to the tensioning device 6 according to the first embodiment—an arrangement is provided where substantially the complete front sides V of both blanks 1 and 2 are accessible for a processing device 9. This is in particular possible because the blanks 1 and 2 are chucked at the holding device 3 only via their peripheral areas (this also applies for the first embodiment).

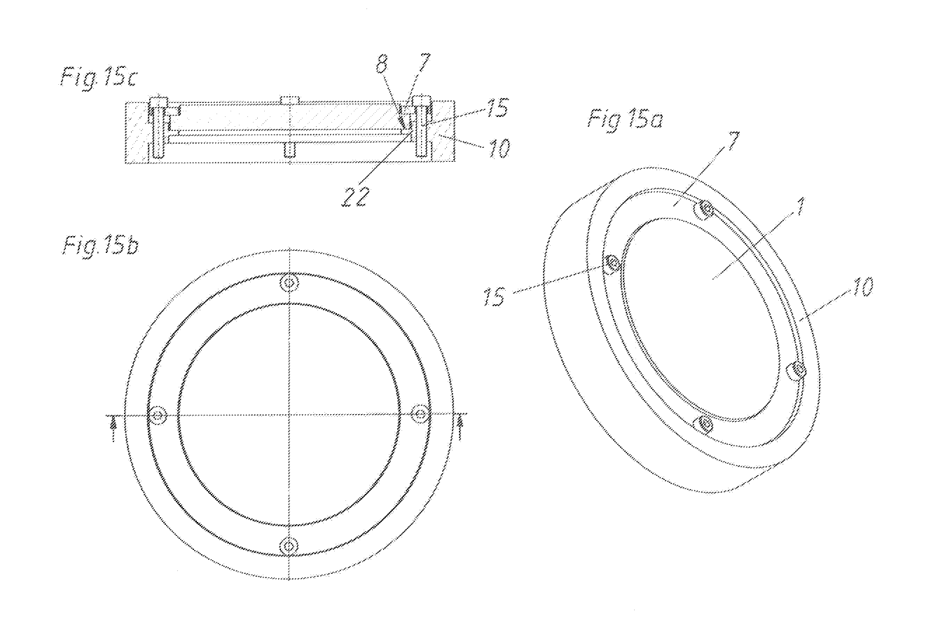

FIG. 15c shows that the holding ring 10 additionally comprises an intermediate piece 22 which also builds the tensioning surface 8.

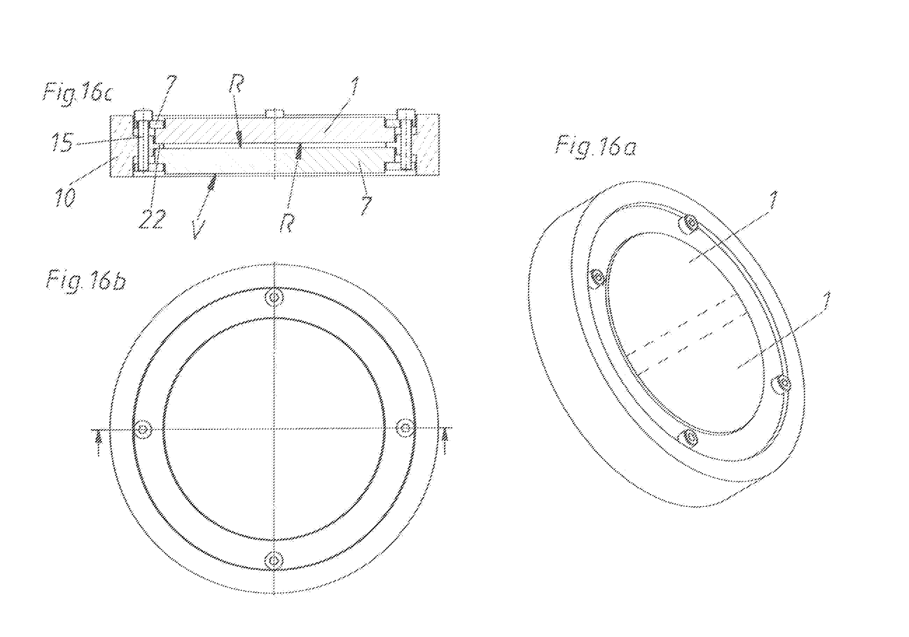

FIG. 16a to 16c show two blanks 1 and 2 which are chucked in such a holding device 3. A second and lower ring-shaped tensioning part 7 is provided additionally. In this case an internal thread can be formed in this lower tensioning part 7 which corresponds to the tensioning pin 15. However, it is also possible that the lower tensioning part 7 can be connected to the holding ring 10 via two tensioning pins 15 “coming from below”, wherein the tensioning pins 15 can be screwed together with the holding ring 10. In FIG. 16a it is indicated by the dashed lines that more than two blanks 1 and 2 can be held in a holding device 3. For example, two separate, spaced and smaller blanks 1 (in this case approximate semicircle-shaped) are chucked in one plane side by side. Thus, it is possible that the second blank 2 can be machined by the processing device 9 at least partly via its back side R. This is also possible if by a previous machining of the first blank 1 a sufficient area is already set at liberty, which allows an access to the back side R of the second blank 2.

### LIST OF REFERENCE SIGNS

1 first blank

2 second blank

3 holding device

4 recesses

5 arrangement

6 tensioning device

7 tensioning part

8 tensioning surface

9 processing device

10 inner holding ring

11 outer holding ring

12 carrier

13 drive motor

14 drive motor

15 tensioning pins

16 positioning groove

17 milling grooves

18 connection bars

19 positioning bore

20 chamfered surface

21 step

22 intermediate piece

K₁ main holding surfaces

K₂ auxiliary holding surfaces

D₁ standard holding thickness

D₂ non-standard holding thickness

V front side

R back side

U circumferential surface

P passive state

K tensioning state

E dental element

G counter holding surface

1. A blank for the production of a dental element, including a first side, a second side and at least one main holding surface for holding the blank at a holding device, wherein the holding surface is spaced from the second side, wherein the blank has a standard holding thickness between the main holding surface and the second side, characterized in that the blank includes at least one auxiliary holding surface for holding the blank at a holding device, wherein the auxiliary holding surface is spaced from the second side, wherein the blank has a non-standard holding thickness between the at least one auxiliary holding surface and the second side, wherein the standard holding thickness is larger than the non-standard holding thickness.

2. The blank according to claim 1, wherein the standard holding thickness is twice as big as the non-standard holding thickness.

3. The blank according to claim 1, wherein the blank is disk-shaped and has a circumferential surface.

4. The blank according to claim 1, wherein several, preferably three, main holding surfaces are arranged on the blank regularly spaced from each other, preferably spaced by 120° each.

5. The blank according to claim 1, wherein several, preferably three, auxiliary holding surfaces are arranged on the blank regularly spaced from each other, preferably spaced by 120° each.

6. The blank according to claim 1, wherein the main holding surface and the auxiliary holding surface are arranged at the blank spaced from each other.

7. The blank according to claim 4, wherein the several main holding surfaces and the several auxiliary holding surfaces are arranged on the blank regularly spaced from each other, preferably spaced by 60° each.

8. The blank according to claim 3, wherein the first side and the second side are formed substantially flat and parallel to each other and the circumferential surface is aligned substantially rectangular to the first side and to the second side.

9. The blank according to claim 8, wherein the at least one main holding surface and the at least one auxiliary holding surface are aligned parallel to the first side and to the second side.

10. The blank according to claim 8, wherein the circumferential surface is substantially in a shape of a circular cylinder jacket.

11. The blank according to claim 8, wherein the at least one main holding surface and the at least one auxiliary holding surface, preferably in the form of recesses, are formed in the first side and in the circumferential surface.

12. A set consisting of a first blank and a second blank each according to the preamble of claim 1, wherein each blank has at least one auxiliary holding surface for holding the respective blank at a holding device, wherein each auxiliary holding surface is spaced from the second side, wherein the blank has a non-standard holding thickness between the at least one auxiliary holding surface and the second side, wherein the addition of the non-standard holding thickness of the first blank and the non-standard holding thickness of the second blank results in the standard holding thickness of both blanks.

13. The set according to claim 12, wherein the non-standard holding thickness of both blanks is equal.

14. The set according to claim 12, wherein both blanks are formed identical.

15. An arrangement including at least two blanks, particularly according to claim 1, and a holding device for holding both blanks, wherein both blanks each have a first side formed as a front side and a second side formed as a back side, characterized in that in a chucked state both blanks are facing to each other with their back sides and substantially the complete front sides of the blanks are accessible.

16. The arrangement according to claim 15, wherein the blanks are disk-shaped and can be chucked to the holding device, preferably only, by peripheral areas.

17. The arrangement according to claim 15, wherein the holding device has at least one, preferably three, tensioning device, wherein by the tensioning device the blanks can be tensioned via their auxiliary holding surfaces to the holding device.

18. The arrangement according to claim 17, wherein the tensioning device has a movable tensioning part and a tensioning surface, wherein in a chucked state an auxiliary holding surface of one of the blanks abuts the tensioning surface and the auxiliary holding surface of the other blank abuts the tensioning part.

19. The arrangement according to claim 18, wherein the movable tensioning part and the tensioning surface of the tensioning device have a substantially unalterable distance to each other, preferably corresponding to the standard holding thickness.

20. The arrangement according to claim 15, wherein both blanks are formed identical.

21. The arrangement according to claim 15, wherein in a chucked state the blanks are abutting each other partly or fully via their back sides.

22. The arrangement according to claim 15, wherein the arrangement comprises a processing device for machining both blanks chucked in the holding device, wherein both blanks can be machined via their substantially completely accessible front sides by the processing device.

23. A method for chucking two blanks according to claim 1 at a holding device, including the steps:
inserting the first blank in the holding device, wherein the first blank abuts a tensioning surface of a tensioning device of the holding device via at least one auxiliary holding surface,
inserting the second blank in the holding device, wherein the blanks are facing with their back sides towards each other and the at least one auxiliary holding surface of the second blank is aligned corresponding to the at least one auxiliary holding surface of the first blank,
moving the tensioning part of the tensioning device of the holding device from a passive state into a tensioning state, so that in the tensioning state the tensioning part abuts the at least one auxiliary holding surface of the second blank and both blanks are commonly chucked via their auxiliary holding surfaces between the tensioning part and the tensioning surface of the tensioning device of the holding device.
